(19) United States
(12) Patent Application Publication
(10) Pub. No.: US 2003/0145499 A1
(43) Pub. Date: Aug. 7, 2003

(54) Stand-alone folding sign

(75) Inventors: Mark Tarter, Mesa, AZ (US); Mark Yeary, Gilbert, AZ (US)

Correspondence Address: Finnegan, Henderson, Farabow,, Garrett & Dunner, L.L.P., 1300 I Street, N.W., Washington, DC, 20005-3315, US

(73) Assignee: The HILLMAN GROUP, INC.

(21) Appl. No.: 10/355,131

(22) Filed: Jan. 31, 2003

Related U.S. Application Data
(60) Provisional application No. 60/353,990, filed on Feb. 5, 2002.

(51) Int. Cl. G09F 15/00; G09F 1/00

(52) U.S. Cl. 40/610; 40/124.16

(57) ABSTRACT

A stand-alone folding sign configured to adapt a stabilizer for providing additional stability against external forces, such as wind or human contacts, is disclosed. The folding sign includes a pair of interlocking legs positioned proximate a lower portion of the sign. The position of the interlocking legs allows a suitable stabilizer to be associated with the legs. The stabilizer may be a weighted object, such as a brick or a container filled with water or sand, or a fixing member that can anchor the sign to the standing surface. A detachable display panel may be created from the sheet forming the sign and displayed in a desirable location.

### DESCRIPTION OF THE INVENTION

1. Field of the Invention

This invention generally relates to folding signs. More particularly, the present invention relates to a corrugated stand-alone folding sign that is configured to adapt a stabilizing means to provide additional stability against destabilizing external forces.

2. Background of the Invention

The concept of a folding sign for displaying messages has been known for a long time. Many different types of materials can be used for the folding sign. For example, the folding sign can be made of heavy, sturdy material such as metal or wood, or light, inexpensive materials such as paper, cardboard, or plastic. The use of light, inexpensive materials is favorable over the use of heavy material because of its lower manufacturing cost and more feasible handling of the sign. However, such a lightweight folding sign is often subject to destabilizing external forces, such as wind or human contacts, and can be easily tipped over.

### SUMMARY OF THE INVENTION

In accordance with the invention, a stand-alone sign is provided. The sign comprises first and second generally opposing surfaces having a top and bottom edge. The first and second opposing surfaces can be connected at their respective top edges, and a pair of legs are provided to connect the first and second opposing surfaces together proximate their respective bottom edges.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments of the invention and together with the description, serve to explain the principles of the invention. In the drawings,

FIG. 1 is a plan view of a corrugated folding sign according to an embodiment of the present invention, illustrating the sign in an unassembled configuration;

FIG. 2 is a perspective view of a corrugated folding sign according to an embodiment of the present invention, illustrating the sign in an assembled configuration; and

FIGS. 3A-C are top, front, and side views, respectively, of a corrugated folding sign according to an embodiment of the present invention.

### DESCRIPTION OF THE EMBODIMENTS

Reference will now be made in detail to the present exemplary embodiments of the invention, which are illustrated in the accompanying drawings. Wherever possible, the same reference numbers will be used throughout the drawings to refer to the same or like parts.

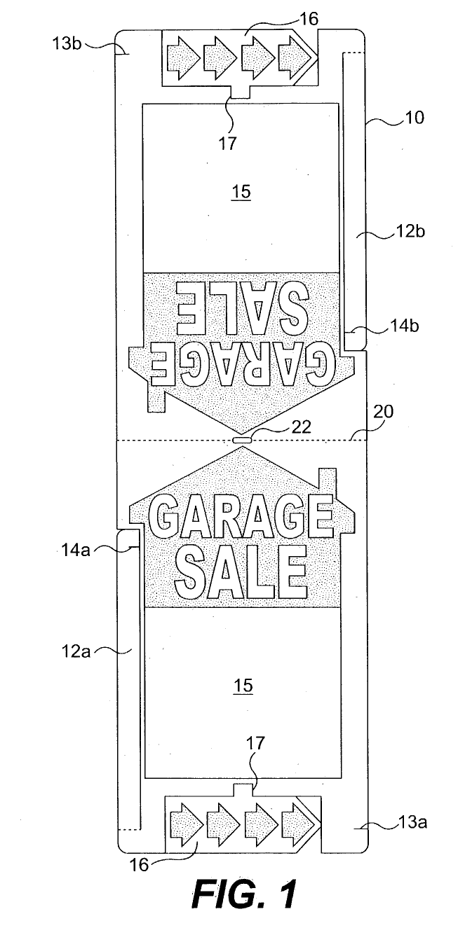

FIG. 1 illustrates an exemplary embodiment of a corrugated stand-alone folding sign in its unassembled configuration of a substantially flat sheet 10. The flat sheet 10 is configured to be folded in half with respect to a center fold 20. Near the center fold 20, a slot 22 is formed for receiving a tab 17 of a detachable panel 16. The detachable panel 16 may be generally formed at and temporarily attached to an end portion of the flat sheet 10. The tab 17 is held securely in the slot 22 when the flat sheet 10 is folded. It should be understood that there may be a plurality of slots 22 formed in the flat sheet 10, so that the sign can hold multiple panels 16. It should also be understood that the slot 22 can be formed at any other desired location in the flat sheet 10.

In this exemplary embodiment, each half of the flat sheet 10 includes a display area 15, an interlocking leg 12a, 12b, a locking slit 13a, 13b, and a detachable panel 16. The locking slit 13a, 13b is formed at a portion proximate to an end of the flat sheet 10. The interlocking leg 12a, 12b is provided with another locking slit 14a, 14b, which is configured to engage the locking slit 13a, 13b of the opposing half of the flat sheet 10. The one end of the interlocking leg 12a, 12b is detachable from the flat sheet 10 and rotatable with respect to the other end fixedly attached to the flat sheet 10. It is contemplated that only one of the locking slit 13a, 13b on the flat sheet 10 or the locking slit 14a, 14b of the interlocking leg 12a, 12b may be utilized to connect the interlocking leg 12a, 12b to the flat sheet 10. Alternatively, another locking mechanism can be utilized.

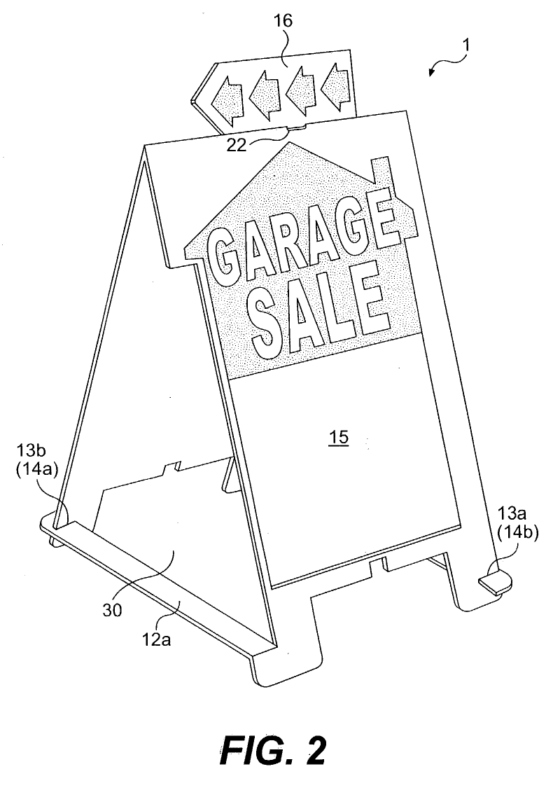

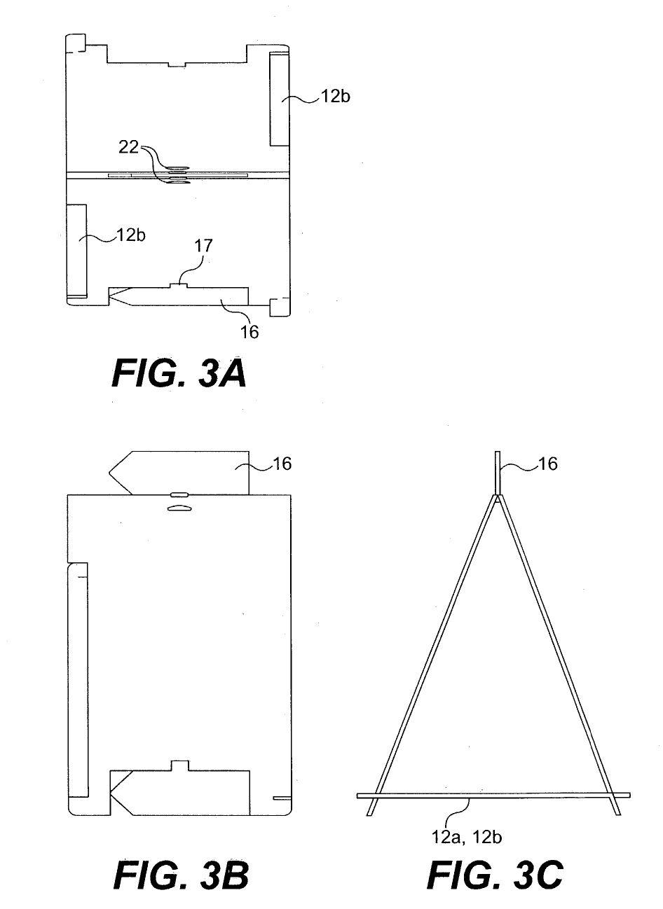

Referring to FIGS. 2 and 3A-C, a corrugated folding sign 1 is shown in its assembled configuration. FIGS. 3A-C illustrate top, front, and side views, respectively, of a corrugated folding sign 1, according to an exemplary embodiment of the present invention. In assembly, the flat sheet 10 is folded in half about the center fold 20, such that the display area 15 on each half faces in opposite direction. The interlocking legs 12a, 12b are detached from the flat sheet 10 and engage the respective locking slits 13a, 13b of the flat sheet 10 with locking slits 14a, 14b formed on the interlocking legs 12a, 12b. Because the locking slits 13a, 13b are positioned at a portion proximate to the end of the flat sheet 10, the interlocking legs 12a, 12b are separated from the standing surface 30 (see FIG. 2) by a small distance and align substantially parallel to the standing surface 30. This position of the interlocking, legs 12a, 12b proximate the standing surface 30 (or ground) allows the use of a stabilizer of some type to be placed on the interlocking legs 12a, 12b. The stabilizer may be, for example, a weighted object, such as a brick or a container filled with water or sand, or a fixing member that can be anchored to the standing surface 30, such as, for example, a nail, screw, bolt, or the like. Since the interlocking legs 12a, 12b are made substantially flexible, the stabilizer can be placed on the interlocking legs 12a, 12b which are configured to bow relative to the standing surface 30 without affecting the structural integrity of the folding sign 1. This stabilizer provides additional stability against destabilizing forces, such as wind or human contacts.

The detachable panel 16 can be removed from a die-cut portion of the flat sheet 10 and attachable to the slot 22 formed at the top portion of the sign 1. Since the folding sign 1 utilizes an otherwise unused portion of the flat sheet 10 for the panel 16, the present invention contemplates efficient use and conservation of materials. As shown in FIGS. 1 and 2, the panels 16 of this exemplary embodiment are used for directional arrows. It is to be noted that the directional arrow can be used for either direction. It should be understood that the panels 16 can be used for any other information or messages to be displayed. It should also be understood that the panels 16 are not necessarily formed from the flat sheet 10. In an alternative embodiment, the panel 16 can be formed and sold separately.

The present invention contemplates that the folding sign 1, after use, may be unfolded into an unassembled configuration for future use. This unassembled configuration can be a substantially flat sheet 10 as shown in FIG. 1 or the sign 1 can simply be collapsed by removing the interlocking legs 12a, 12b from the locking slits 13a, 13b and folded in half.

It is to be understood that both the foregoing general description and the following detailed description are exemplary and explanatory only and are not restrictive of the invention, as claimed. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A stand-alone sign comprising:
first and second generally opposing surfaces having a top and bottom edge, the first and second opposing surfaces being connected at their respective top edges; and
a pair of legs connecting the first and second opposing surfaces together proximate their respective bottom edges.

2. The stand-alone sign of claim 1, further comprising means for stabilizing the sign against external forces, the stabilizing means being in contact with at least one of the pair of legs.

3. The stand-alone sign of claim 1, wherein at least one of the first and second generally opposing surfaces includes a cut-out area, the cut-out area corresponding to a display panel configured to be affixed to the sign in a predetermined location.

4. The stand-alone sign of claim 3, further comprising a slot in the predetermined location for receiving the display panel.

5. The stand-alone sign of claim 1, wherein the pair of legs are integrally formed with the first and second generally opposing surfaces.

6. The stand-alone sign of claim 5, wherein each of the pair of legs extends from the respective one of the first and second generally opposing surfaces to connect to the other of the first and second generally opposing surfaces.

7. The stand-alone sign of claim 1, wherein at least one of the pair of legs includes a locking slit.

8. The stand-alone sign of claim 7, wherein at least one of the first and second generally opposing surfaces includes another locking slit for engaging with the locking slit of one of the pair of legs.

9. The stand-alone sign of claim 1, wherein at least one of the first and second generally opposing surfaces includes a locking slit for receiving one of the pair of legs.
